(19) United States
(12) Patent Application Publication
(10) Pub. No.: US 2011/0282850 A1
(43) Pub. Date: Nov. 17, 2011

(54) Concurrently Accessing Data

(75) Inventors: Vaibhav Kamra, Seattle, WA (US); Pradeep Madhavarapu, Kirkland, WA (US); Cristian Diaconu, Redmond, WA (US); Jun Fang, Sammamish, WA (US); Srini Acharya, Sammamish, WA (US); Michael Warmington, Redmond, WA (US); Maciej Plaza, Bellevue, WA (US); Artem Oks, Bellevue, WA (US); Sankhyayan Debnath, Seattle, WA (US)

(73) Assignee: Microsoft Corporation, Redmond, WA (US)

(21) Appl. No.: 12/777,272

(22) Filed: May 11, 2010

(51) Int. Cl. G06F 17/30

(52) U.S. Cl. 707/704; 707/E17.007; 707/E17.01

(57) ABSTRACT

A database management system having a database component, which includes a lock manager, and a filesystem component. The filesystem component is configured to: generate a mapping between one or more filesystem access modes, one or more filesystem sharing modes and one or more database locks, receive a request from a filesystem stack to perform one or more actions on data in a database, identify a filesystem access mode and a filesystem share mode of the request, determine which one of the database locks corresponds to the filesystem access mode and the filesystem share mode of the request based on the mapping, and receive a notification lock on the data from the lock manager when no other database locks conflict with the notification lock, wherein the notification lock corresponds to the one of the database locks. After receiving the notification lock on the data, the lock manager is configured to send a notification to the filesystem component when a subsequent request from a database stack includes accessing the data.

### BACKGROUND

Certain applications associate metadata with files. These applications either store files in a filesystem and metadata in a database or they store the files inside the database. Storing files in the filesystem and metadata in the database generally leads to problems with managing the two stores. Storing the files in the database along with the metadata generally leads to file-based applications not being able to access files directly. Applications should be able to store files tightly associated with a database, access files through file-based applications and manipulate metadata such as file attributes through data-based applications.

File-based components and database-based components (i.e., file-based applications or programs and database-based applications or programs) in a database management system both access, read and write to data in a file and to metadata associated with the same file. Metadata generally include attributes related to a file such as a file's creation date, author, size etc., while data generally refer to information contained in the file such as the text added within a document. Typically, the metadata of any file is stored in a database file (e.g., MDF file—Microsoft Data File) on a filesystem (e.g., NTFS—New Technology File System) and the data of the file is stored in a separate file (e.g., filesystem file) in the same or different filesystem as the database file.

When a database-based component (i.e., database component) in a database management system accesses metadata stored in the database file, the database component may request a shared lock or an exclusive lock on the corresponding metadata from a lock manager on the database management system. Depending on the type of lock that is issued to the database component by the lock manager, the database component may allow multiple database components to access the data/metadata (i.e., shared lock) or may just allow a single database component to access the data/metadata (i.e., exclusive lock).

When a file-based component (filesystem component), however, accesses data stored in the filesystem file, the filesystem component generally specifies a type of access mode and a type of share mode for the data. The access mode defines whether the filesystem component will perform actions on the data such as reading the data, writing to the data or reading and writing to the data. The share mode defines whether the filesystem component will perform the access mode defined actions on the data while allowing other filesystem components to concurrently read and write to the same data.

In certain instances, data may be stored along with metadata in the database file. As such, filesystem components access the database file to perform its actions on the data. Since database components do not define a desired access mode and a sharing mode like the filesystem component when accessing data or metadata on the database file, conflicts between database components and filesystem components arise when both components request access to the same data or metadata on the database file.

### SUMMARY

Described herein are implementations of various technologies for concurrently accessing data in a database. File-based components and database-based components (i.e., file-based applications or programs and database-based applications or programs) in a database management system both access, read and write to data in a file and to metadata associated with the same file. Metadata include attributes related to a file such as a file's creation date, author, size etc., while data generally refer to information contained in the file such as the text added within a document. Typically, the metadata of any file is stored in a database file (e.g., MDF file—Microsoft Data File) on a filesystem (e.g., NTFS—New Technology File System) with a pointer to a separate file that stores the data of the file (e.g., filesystem file). The separate file may be stored in the same or different filesystem as the database file. However, in order to better manage access to data and metadata, the data may be stored in the database file along with the metadata.

A database-based component (i.e., database component) in a database management system may manage requests from a database application to perform actions such as updating, reading or writing to metadata stored in the database file. As such, when the database component accesses metadata stored in the database file, the database component may request a shared lock or an exclusive lock on the corresponding metadata from a lock manager on the database management system. Depending on the type of lock that is issued to the database component by the lock manager, the database component may allow multiple database applications to access the data/metadata (i.e., shared lock) or may just allow a single database application to access the data/metadata (i.e., exclusive lock).

A file-based component (filesystem component) in a database management system may manage requests from a filesystem application to perform actions such as updating, reading or writing to data stored in the database file or to data stored in the filesystem file. Generally, when the filesystem component accesses data stored in the filesystem file, the filesystem component may specify a type of access mode and a type of share mode for the data. The access mode defines whether the filesystem component will perform actions on the data such as reading the data, writing to the data or reading and writing to the data. The share mode defines whether the filesystem component will perform the access mode defined actions on the data while allowing other filesystem components to concurrently read and write to the same data.

However, when the filesystem component accesses data in the database file, conflicts between database components and filesystem components may arise because the modes specified by the filesystem component are not understood or processed by the database component. As such, when both components request access to the same data or metadata on the database file, conflicts between the database components and filesystem components will arise.

In order to facilitate a filesystem component's and a database component's concurrent access to data, the filesystem component may first generate a mapping between the file component's modes and the database component's locks. After generating the mapping between the file component's modes and the database component's locks, the filesystem component may receive a request from a filesystem stack to perform an action on data or metadata stored on the database file. After receiving the request, the filesystem component may determine the database equivalent lock for the action requested on the metadata based on the mapping. The filesystem component may then send a request to the database lock manager for the database-equivalent lock on the data or the metadata related to the requested action. In one implementation, the filesystem component may request a notification lock on the data/metadata. If the data/metadata currently has a database lock that conflicts with the notification lock, the database lock manager may send an error to the filesystem component indicating the conflict. If, however, the data/metadata does not have a lock taken on it, the database lock manager may issue the filesystem component the requested notification lock on the data/metadata. After issuing the notification lock on the data/metadata, the filesystem component may then store the data/metadata in a cache such that future requests for the data/metadata may be processed more quickly. In one implementation, the filesystem component may continue to hold the notification lock on the data/metadata when storing the data/metadata in the cache even though there may not be an active handle using the data/metadata.

When a database component requests access to data/metadata that currently has a notification lock being held by the filesystem component, the filesystem component may receive a notification from the database lock manager indicating that the database component has requested the notification lock to obtain access to the data/metadata. Upon receiving the notification from the database lock manager, the filesystem component may determine whether it will release the notification lock on the data/metadata or whether it will continue to hold the notification lock on the data/metadata based on whether an active handle has closed the data/metadata.

If an active handle of the filesystem component has closed the data/metadata (i.e., the data/metadata is stored in cache), the filesystem component may release the notification lock on the data/metadata to allow the database component access to the data/metadata. If, however, an active handle of the file component is currently accessing the data/metadata or is open, the filesystem component may continue to hold the notification lock until the active handle is closed. After the active handle is closed, the filesystem component may remember that the notification was received and it may subsequently release the notification lock associated with the data/metadata so that the database component may obtain access to the metadata.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic diagram of a computing system in which the various techniques described herein may be incorporated and practiced.

FIG. 2 illustrates a schematic diagram of a database system in which the various techniques described herein may be incorporated and practiced.

FIG. 3 illustrates a flow diagram of a method for facilitating concurrent access to data in a database system in accordance with one or more implementations of various techniques described herein.

FIG. 4 illustrates an example system in which the various techniques described herein may be incorporated and practiced.

### DETAILED DESCRIPTION

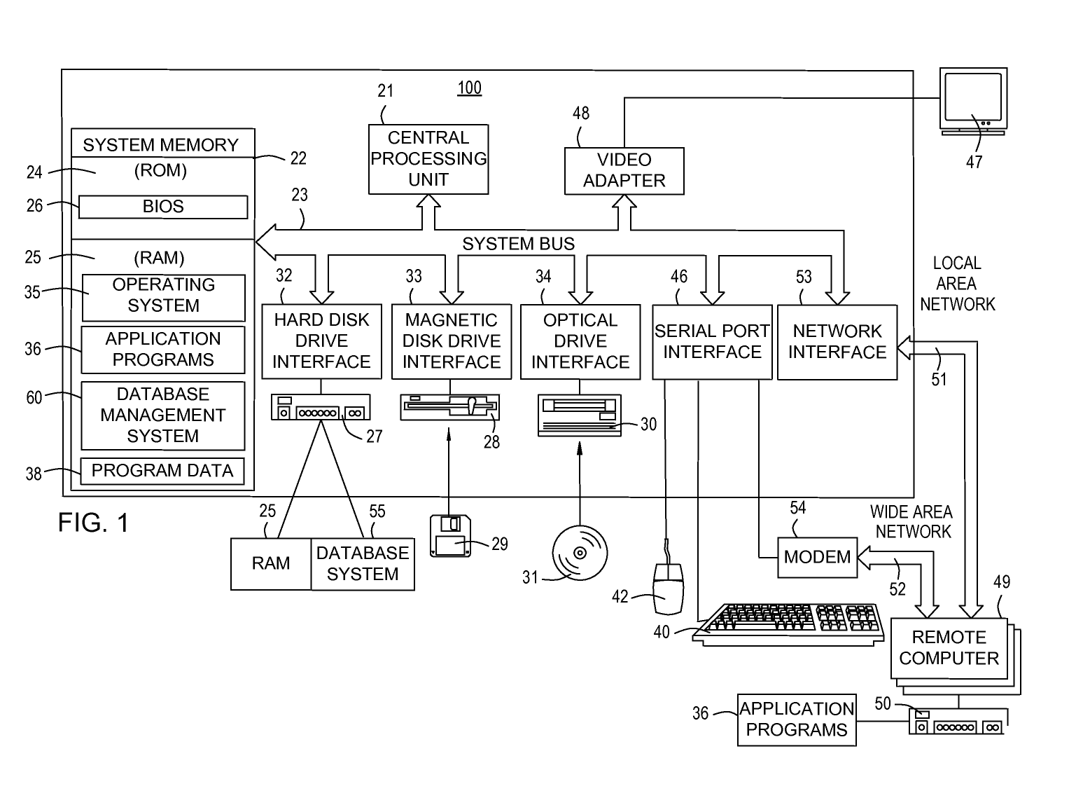

In general, one or more implementations described herein are directed to facilitating concurrent access to data. Various techniques for concurrently accessing data in a database system will be described in more detail with reference to FIGS. 1-4.

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of any of the above may also be included within the scope of computer readable media.

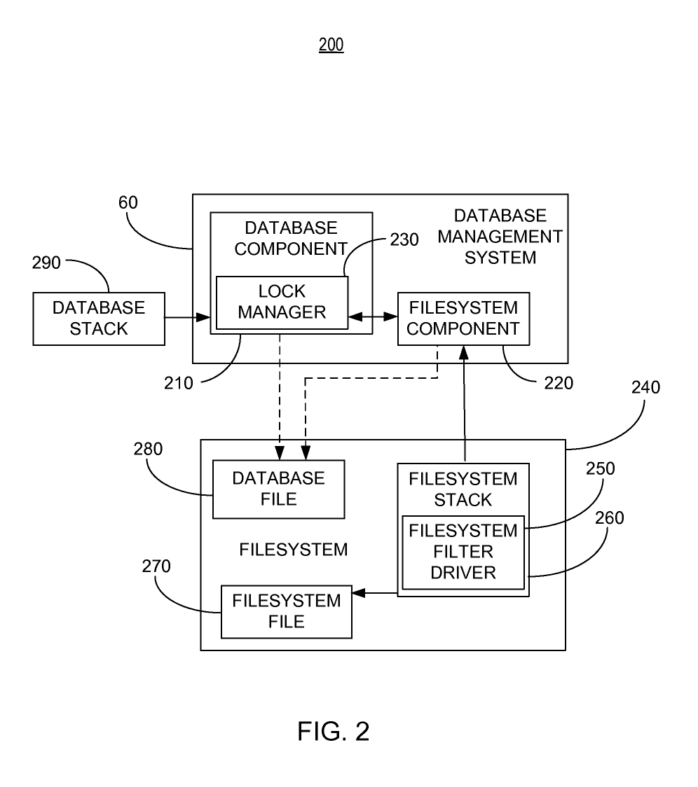

A number of program modules may be stored on the hard disk 27, magnetic disk 29, optical disk 31, ROM 24 or RAM 25, including an operating system 35, one or more application programs 36, a database management system 60, program data 38, and a database system 55. The operating system 35 may be any suitable operating system that may control the operation of a networked personal or server computer, such as Windows® XP, Mac OS® X, Unix-variants (e.g., Linux® and BSD®), and the like. The database management application 60 may be configured to manage concurrent access to data by different components. The database management system 60 will be described in more detail with reference to FIGS. 2-4 in the paragraphs below.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices such as speakers and printers.

Further, the computing system 100 may operate in a networked environment using logical connections to one or more remote computers 49. The logical connections may be any connection that is commonplace in offices, enterprise-wide computer networks, intranets, and the Internet, such as local area network (LAN) 51 and a wide area network (WAN) 52. The remote computers 49 may each include application programs 36 similar to that of the computer action function 60.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a schematic diagram of a database system 200 in which the various techniques described herein may be incorporated and practiced. The following description of database system 200 is made with reference to computing system 100 of FIG. 1. Database system 200 includes database management system 60, database component 210, filesystem component 220, lock manager 230, filesystem 240, filesystem filter driver 250, filesystem stack 260, filesystem file 270, database file 280 and database stack 290.

Database component 210 may be located within the database management system 60 and may be described as the code portion of the database management system 60 that includes a relational database. The relational database may interact with tables, columns and rows in the database file 280. In one implementation, the database file 280 may be stored on the filesystem 240, however, it should be noted that in other implementations database file 280 may be stored in any other memory device. In one implementation, database file 280 may be a Microsoft Data File (i.e., MDF file) and may include tables, columns and rows which may be associated with metadata. Metadata may include attributes related to a file such as a file's creation date, author, size etc. Database component 210 may be configured to manage access to the metadata in the database file 280 from a database application. The database application may place requests for access to the metadata on database stack 290 which may then be received by database component 210.

Filesystem 240 may be a New Technology File System (NTFS) or the like. In one implementation, filesystem 240 may include filesystem stack 260, database file 280 and filesystem file 270. Filesystem stack 260 may include requests from a file-based application for access to data stored on filesystem file 270, metadata stored on database file 280, data stored on database file 280, or combinations thereof.

Filesystem component 220 may be located within the database management system 60 and may be described as the code portion of the database management system 60 that manages requests from the filesystem 240 to access data/metadata stored on the database file 280 or data stored on the filesystem file 270. Data may include information entered into a file. For example, in a document, the text entered into the document may be stored as data in the filesystem file 270. In one implementation, each data blob may be stored on a separate filesystem file 270. The metadata associated with the data may include the author of the document, the last time at which the document was modified, and the like.

Filesystem 240 may receive the requests from file-based applications via filesystem stack 260. File-based applications may include software such as Microsoft Office® products, Adobe Reader®, Windows Media Player® and the like. In one implementation, the file-based applications are stored in the filesystem 240. Filesystem stack 260 may include filesystem filter driver 250 which may be configured to intercept all requests to access the data/metadata related to filesystem file 270. After intercepting the requests to access the data/metadata, filesystem filter driver 250 may forward the request from the filesystem stack 260 to the filesystem component 220.

After receiving the request from filesystem stack 260, filesystem component 220 may interact with lock manager 230 to obtain a lock on data/metadata stored on the database file 280 associated with the requests to access the data/metadata related to filesystem 270. The lock issued by lock manager 230 may provide the file-based application access to the data/metadata associated with the request it placed on filesystem stack 260.

Like filesystem component 220, database component 210 may receive requests by a database application to access data/metadata stored on database file 280 from database stack 290. In one implementation, the data may be stored on filesystem file 270 and the metadata may be stored on database file 280.

Database stack 290 may include requests from a Transact SQL (TSQL) protocol and the like. Database component 210 may also interact with the lock manager 230 to obtain a lock on data/metadata stored on the database file 280 in order to provide the database application access the metadata.

In one implementation, each request placed on filesystem stack 260 may include information pertaining to an access mode and a share mode related to the file-based application's request. The access mode and share mode for each request on filesystem stack 260 may be specified by a handle of the file-based application that placed the request on filesystem stack 260. The access mode may define whether the request includes actions that may read, write, read and write or do neither to the data/metadata. The sharing mode may define whether other actions may be performed by other handles while the handle that placed the request on filesystem stack 260 is performing its action on the data/metadata.

Database component 210, however, may not receive information related to an access mode or a share mode on a request placed on database stack 290. Instead, database component 210 may issue either shared locks or exclusive locks via lock manager 230 on data/metadata being accessed by the database application based on the action specified in the request. For example, if a request from database stack 290 accesses data/metadata to read from the data/metadata, lock manager 230 may issue a shared lock on the data/metadata to the database application that placed the corresponding request for access to the data/metadata. The shared lock may allow other database applications to read the data/metadata while the database application that requested the access to the data/metadata reads the data/metadata as well. If, however, the request from database stack 290 includes a request to write to the data/metadata, the lock manager 230 may issue an exclusive lock on the data/metadata to the database application that placed the corresponding request for access to the data/metadata. The exclusive lock may allow a single database application access to the data/metadata until the exclusive lock is released.

In one implementation, a shared lock issued on a row in database file 280 may also include an intent shared lock on the hierarchy above the row such as a page, row set and table that corresponds to the row. Similarly, when an exclusive lock is issued on the row in the database, lock manager 230 may issue an intent exclusive lock on the hierarchy above the row such as a page, row set and table that corresponds to the row.

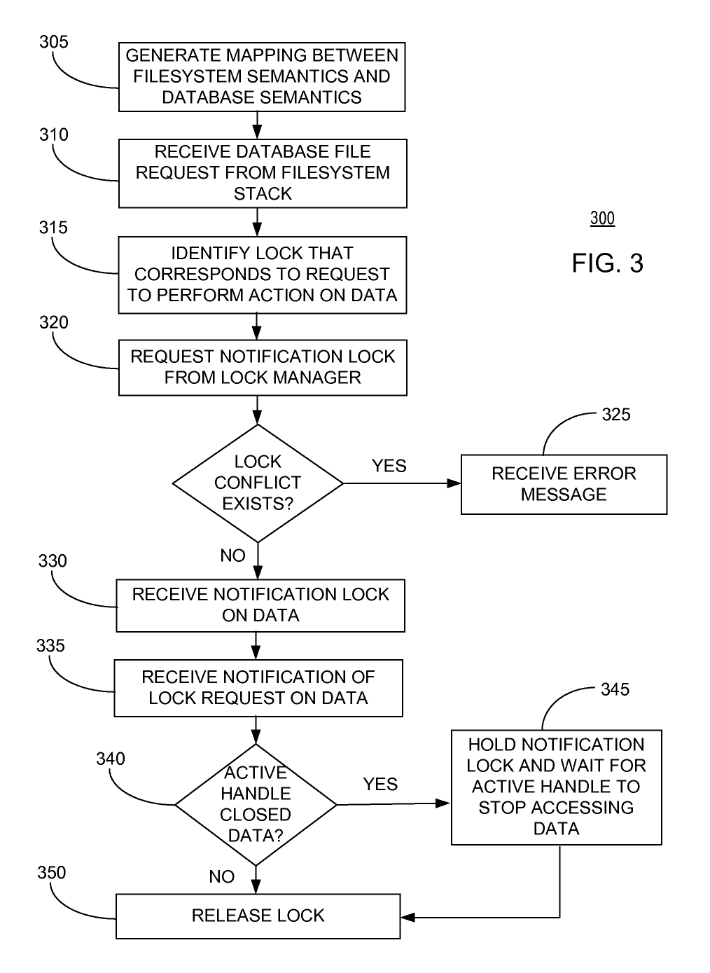

FIG. 3 illustrates a flow diagram of a method for facilitating concurrent access to data in a database system in accordance with one or more implementations of various techniques described herein. The following description of method 300 is made with reference to computing system 100 of FIG. 1 and database system 200 of FIG. 2. It should be understood that while method 300 indicates a particular order of execution of the operations, in some implementations, certain portions of the operations might be executed in a different order. In one implementation, the method for facilitating concurrent access to data may be performed by filesystem component 220.

At step 305, filesystem component 220 may generate a mapping between filesystem semantics and database semantics. Filesystem semantics may include the modes (i.e., access and share modes) that a handle from the file-based application may specify when it requests access to data/metadata in the database file 280. Database semantics may include locks (i.e., shared and exclusive locks) issued on data/metadata by lock manager 230 based on how a database application that requests access to the data/metadata may use the data/metadata (e.g., read/write to data/metadata).

In one implementation, when a handle from a file-based application places a request on the filesystem stack 260 to access a data/metadata in the filesystem file 270 or in the database file 280, the handle may specify an access mode parameter and a share mode parameter associated with the request. As mentioned above, the access mode parameter may specify whether the handle intends to read, write, read and write or do neither to data/metadata in the filesystem file 270 nor to data/metadata on the database file 280. The sharing mode parameter may specify whether the handle allows other handles to share access to the data/metadata for reading, writing, both or neither. As such, the sharing mode parameter may affect how other handles may subsequently access the data or the metadata once a handle has obtained access to the data or the metadata.

In one implementation, concurrent access to the data in the filesystem file 270 by two or more handles is controlled by filesystem component 220 based on the access mode parameter and the sharing mode parameter specified by the handle that accesses the data. The mapping generated at step 305, however, may be used to facilitate concurrent access to data/metadata stored in the database file 280 by a file-based application and a database application. In order to facilitate this concurrent access to the data/metadata, the mapping generated at step 305 may identify database locks that correspond to the modes specified by the handle. Lock manager 230 may then control concurrent access to the data/metadata using the identified locks.

Because locks do not specify the types of allowed concurrent access to data/metadata, locks cannot be used to facilitate concurrent access to the data/metadata using access mode parameters and share mode parameters. For example, a READ access mode along with a FILE_SHARE_WRITE share mode cannot be represented in a straightforward manner using locks. If a shared lock is issued to a file-based application, the shared lock may prevent an update (e.g., write) from being implemented on data/metadata if the update tries to obtain an exclusive lock on the same data/metadata from the lock manager. For this reason, database management system 60 may ignore some sharing modes when generating the mapping at step 305. Instead, the mapping between filesystem semantics and database semantics may be determined based on the intent of the operation (e.g., READ or WRITE) and may then be further restricted based on the specified sharing mode. Some examples of how filesystem access and share modes may be mapped to locks are provided below.

A filesystem stack 260 request for read access may be mapped to a share lock. In this manner, when the filesystem stack 260 request includes a request to open a file or directory on database file 280 with a read access, the mapping determined at step 305 may associate the read access request to a shared lock on the row in database file 280 that represents the file or directory that has been opened.

A filesystem stack 260 request for write access may be mapped to an exclusive lock. In this manner, when the filesystem stack 260 request includes a request to open a file or directory on database file 280 with a write access, the mapping determined at step 305 may associate the write access to an exclusive lock on the row in database file 280 that represents the file or directory that has been opened.

A filesystem stack 260 request that includes a sharing mode parameter specifying read and write access may be mapped separately based on the access mode. For example, a sharing mode with read access may be mapped to a share lock. A sharing mode with write access, however, may be mapped to an exclusive lock.

The mappings between share and access modes and locks may be summarized in the table below.

| Access | | |
|---|---|---|
| Mode | Sharing Mode | Mapped Lock |
| READ | NONE | N/A |
| | (Exclusive) | |
| READ | SHARE_READ | Share Lock |
| READ | SHARE_WRITE | N/A |
| READ | SHARE_ALL | Share Lock |
| WRITE | NONE | Exclusive Lock |
| | (Exclusive) | |
| WRITE | SHARE_READ | Exclusive Lock |
| WRITE | SHARE_WRITE | Exclusive Lock |
| WRITE | SHARE_ALL | Exclusive Lock |

At step 310, filesystem component 220 may receive a request from filesystem stack 260 to perform an action (i.e., read/write) on data/metadata stored in database file 280. In one implementation, the request from filesystem stack 260 may have been intercepted by filesystem filter driver 250. Filesystem filter driver 250 may examine each request in filesystem stack 260 and may forward any request for access to data/metadata stored in database file 280 to filesystem component 220. As mentioned above, the request from filesystem stack 260 may include access mode and share mode parameters as specified by the handle that placed the request in filesystem stack 260.

At step 315, filesystem component 220 may identify a lock that corresponds to the request received at step 310 based on the access mode and share mode parameters as specified by the request and the mapping generated at step 305.

At step 320, filesystem component 220 may request a notification lock from lock manager 230. The notification lock may correspond to the lock identified at step 315 from lock manager 230. For example, when a filesystem stack 260 request includes opening a file or directory in database file 280 in a shared read mode, filesystem component 220 may use the mapping generated at step 305 to determine that a shared lock corresponds to the filesystem stack 260 request. Filesystem component may then request a notification share lock on the file or directory in database file 280 from lock manager 230.

After receiving the request for the notification lock from filesystem component 220, lock manager 230 may determine whether the notification lock request conflicts with any other lock currently issued to database component 210 by lock manager 230 on the same data/metadata. If lock manager 230 determines that there is a lock issued to database component 210 on the same data/metadata that conflicts with the notification lock request of step 320, filesystem component 220 may receive an error message (i.e., step 325) indicating that the notification lock requested conflicts with a lock issued on the data/metadata. If, however, lock manager 230 determines that there is no lock issued on the data/metadata to database component 210 that conflicts with the notification lock request of step 320, filesystem component 220 may proceed to step 330.

The table below illustrates when a request from database stack 290 and a request from filesystem stack 260 may conflict with each other. In the table below N represents no conflict, C represents a conflict, NL represents no lock, S represents shared lock and X represents exclusive lock.

| | | 2nd Operation | | | | | | | |
|---|---|---|---|---|---|---|---|---|---|
| | | | Handle | Handle | User Query | | | | |
| | | | open for | open for | Read | Read | Repeatable | | |
| 1st Operation | | | READ | WRITE | Uncommitted | Committed | Read | Serializable | Update |
| | | Lock | S | X | NL | S | S | S | X |
| | | Mode | | | | | | | |
| User | Read | NL | N | N | N | N | N | N | N |
| Query | Uncommitted | | | | | | | | |
| | Read | S | N | C | N | N | N | N | C |
| | Committed | | | | | | | | |
| | Repeatable | S | N | C | N | N | N | N | C |
| | Read | | | | | | | | |
| | Serializable | S | N | C | N | N | N | N | C |
| Update | | X | C | C | N | C | C | C | C |
| Open READ | | S | Depends | Depends | N | N | N | N | C |
| | | | on | on | | | | | |
| | | | Sharing | Sharing | | | | | |
| | | | Mode. | Mode. | | | | | |
| Open WRITE | | X | Depends | Depends | N | C | C | C | C |
| | | | on | on | | | | | |
| | | | Sharing | Sharing | | | | | |
| | | | Mode. | Mode. | | | | | |

At step 330, filesystem component 220 may receive the notification lock on the data/metadata requested in step 310 from lock manager 230. The notification lock may be configured to prompt lock manager 230 to provide a notification to filesystem component 220 when any lock request is made by database component 210 for the data/metadata associated with the notification lock. Although notification lock has been described as configured to prompt lock manager 230 to provide a notification to filesystem component 220 when any lock request is made by database component 210 for the data/metadata associated with the notification lock, it should be noted that in other implementations the notification lock may be configured to prompt lock manager 230 to provide a notification to any component in computing system 100 when any lock request is made by database component 210 for the data/metadata associated with the notification lock.

In one implementation, if filesystem component 220 receives a notification lock on the data/metadata, filesystem component 220 may set a pointer on a notification data structure. The notification data structure may be used to indicate to lock manager 230 that notification locks currently exist on the data/metadata. In this manner, lock manager 230 may continuously check for notification locks when receiving subsequent lock requests from database component 210. If the notification data structure is null, lock manager 230 may not check for notification locks when receiving subsequent commands from database component 210.

Lock manager 230 may be configured to send filesystem component 220 a notification when data/metadata that is associated with a notification lock is being accessed by database component 210. In this manner, the lock manager 230 may be configured to manage how filesystem component 220 and database component 210 may concurrently access data/metadata. In one implementation, lock manager 230 may include a list of the components that are to be notified when a request for a lock on data/metadata associated with the notification lock is made.

At step 335, filesystem component 220 may receive a notification indicating that database component 210 has requested access to the data/metadata associated with the notification lock. In one implementation, when caching is enabled, filesystem component 220 may continue to hold its notification lock on the data/metadata even after all other filesystem handles have stopped using/accessing the data/metadata. As such, at step 340, filesystem component 220 may determine whether a handle from the filesystem 240 has closed the data/metadata associated with the notification lock.

If filesystem component 220 determines that at least one handle is currently active and still accessing the data/metadata, filesystem component 220 may proceed to step 345. At step 345, filesystem component 220 may continue to hold the notification lock on the data/metadata until the handle currently accessing the data/metadata is closed. In one implementation, at step 345, filesystem component 220 may remember that a notification pertaining to the data/metadata has been received and may proceed to step 350 immediately after the active handle is closed.

Referring back to step 340, if filesystem component 220 determines that no handle is currently accessing the data/metadata and no handle is open to the data/metadata, filesystem component 220 may proceed to step 350. At step 350, filesystem component 220 may release the notification lock on the data/metadata.

In one implementation, when filesystem component 220 holds or releases a lock on data/metadata that is stored in a cache, a spinlock may also be issued on the same data/metadata to protect an internal data structure of the data/metadata in the memory of filesystem 240. Spinlocks may be held while changes are made to the internal data structure due to the changes made by the requests in filesystem stack 260 or database stack 290. In this case, lock manager 230 may generate a list of components that should be notified of a conflict with the lock while holding the spinlock. In this manner, lock manager 230 may release the spinlock and subsequently send the notifications to the appropriate components about any existing conflict. As such, lock manager 230 may not have to hold onto the spinlock if a conflict exists to ensure that the spinlock continues to protect the internal data structure of the data/metadata which reduces the amount of time that a spinlock is held. By reducing the amount of time that a spinlock is held, lock manager may increase the scalability and performance of method 300.

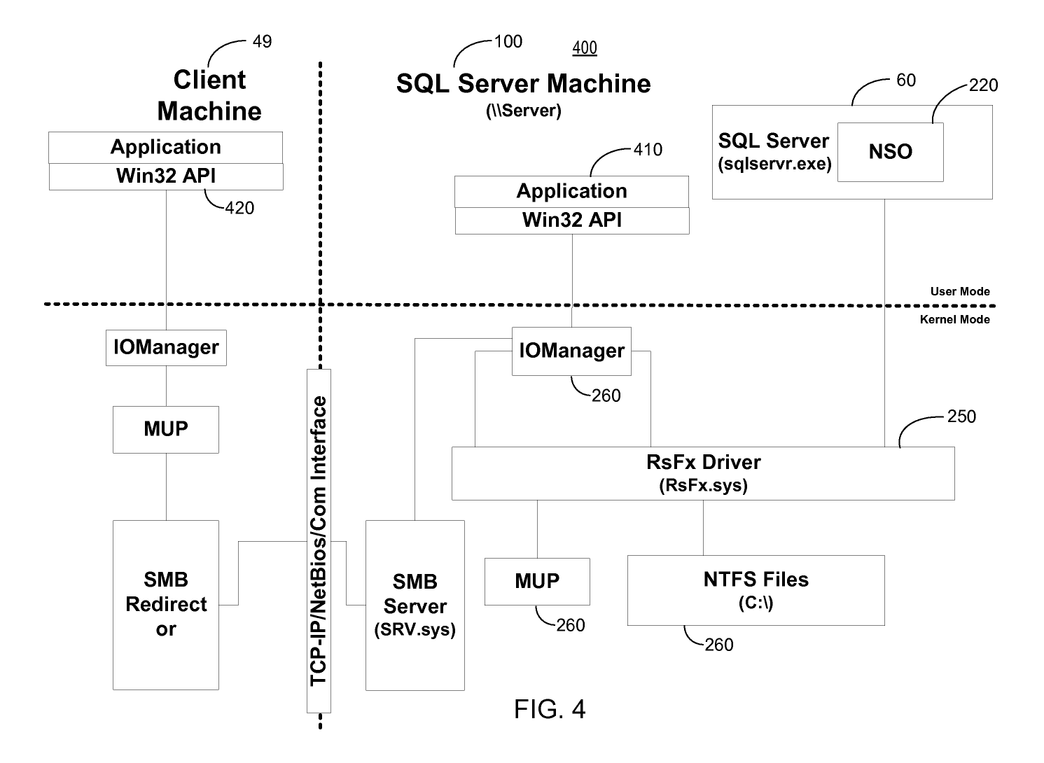

FIG. 4 illustrates an example system 400 in which the various techniques described herein may be incorporated and practiced. The following description of system 400 is made with reference to computer system 100 of FIG. 1 and database system 200 of FIG. 2. System 400 includes application 410 stored on a SQL Server Machine. In one implementation, SQL Server Machine may correspond to computer system 100. As such, SQL Server may correspond to database management system 60, and Namespace Owner (NSO) may represent filesystem component 220. Application 410 may represent an application that uses filesystem stack 260. Filesystem stack 260 is represented in system 400 by Input-Output Manager (IOManager), Multiple Uniform Naming Convention Provider (MUP) and New Technology File System (NTFS) files as shown in FIG. 4. RsFx Driver may correspond to filesystem filter driver 250. As such, IOManager, MUP and NTFS files (i.e., filesystem stack 260) may each be input into RsFx Driver (i.e., filesystem filter driver 250) such that RsFx Driver may intercept all filesystem stack 260 requests for access to a database file and forward the filesystem stack 260 requests to SQL Server (i.e., database management system 60). In one implementation, client machine may be stored on remote computer 49 and may include an application 420 that may also use filesystem stack 260 via a network connection.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing access to data, comprising:
receiving a request from a filesystem stack to perform one or more actions on data in a database;
identifying a filesystem access mode and a filesystem share mode of the request;
determining a database lock that corresponds to the filesystem access mode and the filesystem share mode of the request based on a mapping between the filesystem access mode, the filesystem sharing mode and the database lock; and
receiving a notification lock on the data, wherein the notification lock corresponds to the database lock.

2. The method of claim 1, wherein the notification lock is configured to prompt a lock manager to send a notification to a component on a computing system when a subsequent request from a database stack includes accessing the data.

3. The method of claim 2, wherein the component is a filesystem component.

4. The method of claim 1, wherein the notification lock is received when no other database locks conflict with the notification lock.

5. The method of claim 1, wherein the request from the filesystem stack is received from a filesystem filter driver that is configured to intercept one or more requests for the data from the filesystem stack.

6. The method of claim 1, wherein the filesystem access mode and the filesystem share mode are specified by a handle that places the request on the filesystem stack.

7. The method of claim 1, wherein the data is metadata.

8. A database management system, comprising:
a database component having a lock manager;
a filesystem component configured to:
generate a mapping between one or more filesystem access modes, one or more filesystem sharing modes, and one or more database locks;
receive a request from a filesystem stack to perform one or more actions on data in a database;
identify a filesystem access mode and a filesystem share mode of the request;
determine which one of the database locks corresponds to the filesystem access mode and the filesystem share mode of the request based on the mapping; and
receive a notification lock on the data from the lock manager when no other database locks conflict with the notification lock, wherein the notification lock corresponds to the one of the database locks.

9. The database management system of claim 8, wherein the request from the filesystem stack is received from a filesystem filter driver that is configured to intercept one or more requests for the data from the filesystem stack.

10. The database management system of claim 8, wherein the filesystem access mode and the filesystem share mode are specified by a handle that places the request on the filesystem stack.

11. The database management system of claim 8, wherein the lock manager is configured to:
receive a request for the notification lock from the filesystem component; and
send the notification lock on the data to the filesystem component when no other database locks conflict with the notification lock.

12. The database management system of claim 8, wherein the lock manager is configured to send an error message to the filesystem component when one or more other database locks conflict with the notification lock.

13. The database management system of claim 8, wherein the filesystem component is further configured to:
receive a notification indicating that the database component has requested the notification lock; and
release the notification lock when the data has been closed by one or more handles.

14. The database management system of claim 8, wherein the filesystem component is further configured to:
receive a notification indicating that the database component has requested the notification lock; and
hold the notification lock when the data is being accessed by one or more handles.

15. The database management system of claim 14, wherein the filesystem component is further configured to release the notification lock after the one or more handles are closed.

16. A computer-readable storage medium having stored thereon computer-executable instructions which, when executed by a computer, cause the computer to:
generate a mapping between one or more filesystem access modes, one or more filesystem sharing modes, and one or more database locks;
receive a request from a filesystem stack to perform one or more actions on data in a database;
identify a filesystem access mode and a filesystem share mode of the request;
determine which one of the database locks corresponds to the filesystem access mode and the filesystem share mode of the request based on the mapping;
receive a notification lock on the data from a lock manager when no other database locks conflict with the notification lock, wherein the notification lock corresponds to the one of the database locks; and
receive an error message when one or more other database locks conflict with the notification lock.

17. The computer-readable storage medium of claim 16, wherein the lock manager is configured to:
receive a request for the notification lock; and
send the notification lock on the data when no other database locks conflict with the notification lock.

18. The computer-readable storage medium of claim 16, wherein the lock manager is configured to send the error message when the one or more other database locks conflict with the notification lock.

19. The computer-readable storage medium of claim 16, wherein the computer-executable instructions which, when executed by a computer, further cause the computer to:
receive a notification indicating that a database component has requested the notification lock; and
release the notification lock when the data is not being accessed by one or more open handles.

20. The computer-readable storage medium of claim 16, wherein the computer-executable instructions which, when executed by a computer, further cause the computer to:
receive a notification indicating that a database component has requested the notification lock; and
hold the notification lock when the data is being accessed by one or more handles.
